(19) United States
(12) Patent Application Publication
(10) Pub. No.: US 2021/0357783 A1
(43) Pub. Date: Nov. 18, 2021

(54) DATA PRIORITIZATION ACROSS PREDICTIVE INPUT CHANNELS

(71) Applicant: Optum Services (Ireland) Limited, Dublin (IE)

(72) Inventors: Peter Cogan, Dublin (IE); Conor Breen, Dublin (IE); Anthony R. O'Neill, Dublin (IE); Niamh Belton, Longford (IE); Ciaran McKenna, Dublin (IE); Evan Murphy, Kildare (IE)

(21) Appl. No.: 16/876,364

(22) Filed: May 18, 2020

(51) Int. Cl. G06N 5/04; G06Q 10/04; G06N 20/00; G06F 16/25

(52) U.S. Cl. CPC G06N 5/04; G06F 16/25; G06N 20/00; G06Q 10/04

(57) ABSTRACT

There is a need for more effective and efficient data prioritization with respect to predictive input entities across predictive input channels. This need can be addressed by, for example, techniques for prospective prioritization that utilize supervised machine learning models. In one example, a method includes determining a prospective priority score for each predictive input entity of a group of predictive input entities based on a predictive input channel for the predictive input entity and performing prospective prioritization of the group of predictive input entities based on each prospective priority score for a predictive input entity.

### BACKGROUND

Various embodiments of the present invention address technical challenges related to data prioritization across predictive input channels and disclose various innovative techniques for prospective prioritization of predictive input entities across predictive input channels.

### BRIEF SUMMARY

In general, embodiments of the present invention provide methods, apparatuses, systems, computing devices, computing entities, and/or the like for data prioritization with respect to predictive input entities across predictive input channels. Various embodiments of the present invention disclose techniques for prospective prioritization across predictive input channels. Predictive input channels may comprise inventories corresponding with predictive input entities. The inventory of a predictive input channel may be generated according to rule-based or model-based evaluation techniques and correspond with real-time or prospective timeframes. Inventory from a plurality of predictive input channels may be combined by performing predictive tasks with respect to each predictive input entity such that cross-channel data can be aggregated and prioritized.

In accordance with one aspect, a method is provided. In one embodiment, the method comprises for each predictive input entity of the plurality of predictive input entities, determining a predictive input channel of a plurality of predictive input channels that is associated with the predictive input entity, wherein the plurality of predictive input channels comprise a model-based prospective channel, a rule-based prospective channel, a model-based real-time channel, and a rule-based real-time channel; determining a prospective triggering event occurrence predictive output for the predictive input entity based on the predictive input channel for the predictive input entity; determining a prospective qualifying criteria satisfaction predictive output for the predictive input entity based on the predictive input channel for the predictive input entity; determining a prospective cost predictive output for the predictive input entity based on the predictive input channel for the predictive input entity; and determining the prospective priority score for the predictive input entity based on the prospective triggering event occurrence predictive output for the predictive input entity, the prospective qualifying criteria satisfaction predictive output for the predictive input entity, and the prospective cost predictive output for the predictive input entity; and performing the prospective prioritization based on each prospective priority score for a predictive input entity of the plurality of predictive input entities.

In accordance with another aspect, an apparatus for performing prospective prioritization of a plurality of predictive input entities, the apparatus comprising at least one processor and at least one memory including a computer program code, the at least one memory and the computer program code configured to, with the at least one processor, cause the apparatus to: for each predictive input entity of the plurality of predictive input entities, determine a predictive input channel of a plurality of predictive input channels that is associated with the predictive input entity, wherein the plurality of predictive input channels comprise a model-based prospective channel, a rule-based prospective channel, a model-based real-time channel, and a rule-based real-time channel; determine a prospective triggering event occurrence predictive output for the predictive input entity based on the predictive input channel for the predictive input entity; determine a prospective qualifying criteria satisfaction predictive output for the predictive input entity based on the predictive input channel for the predictive input entity; determine a prospective cost predictive output for the predictive input entity based on the predictive input channel for the predictive input entity; and determine the prospective priority score for the predictive input entity based on the prospective triggering event occurrence predictive output for the predictive input entity, the prospective qualifying criteria satisfaction predictive output for the predictive input entity, and the prospective cost predictive output for the predictive input entity; and perform the prospective prioritization based on each prospective priority score for a predictive input entity of the plurality of predictive input entities.

In accordance with yet another aspect, a non-transitory computer storage medium comprising instructions for performing prospective prioritization of a plurality of predictive input entities, the instructions being configured to cause one or more processors to at least perform operations configured to: for each predictive input entity of the plurality of predictive input entities, determine a predictive input channel of a plurality of predictive input channels that is associated with the predictive input entity, wherein the plurality of predictive input channels comprise a model-based prospective channel, a rule-based prospective channel, a model-based real-time channel, and a rule-based real-time channel; determine a prospective triggering event occurrence predictive output for the predictive input entity based on the predictive input channel for the predictive input entity; determine a prospective qualifying criteria satisfaction predictive output for the predictive input entity based on the predictive input channel for the predictive input entity; determine a prospective cost predictive output for the predictive input entity based on the predictive input channel for the predictive input entity; and determine the prospective priority score for the predictive input entity based on the prospective triggering event occurrence predictive output for the predictive input entity, the prospective qualifying criteria satisfaction predictive output for the predictive input entity, and the prospective cost predictive output for the predictive input entity; and perform the prospective prioritization based on each prospective priority score for a predictive input entity of the plurality of predictive input entities.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example prospective prioritization computing entity in accordance with some embodiments discussed herein.

FIG. 3 provides an example client computing entity in accordance with some embodiments discussed herein.

FIG. 4 is a flowchart diagram of an example process for prioritizing data across a plurality of predictive input channels in accordance with some embodiments discussed herein.

FIG. 5 is an exemplary organizational diagram defining types of predictive input channels in accordance with some embodiments discussed herein

FIG. 6 provides an operational example of predictive input channels and corresponding models which may be used for predictive tasks in accordance with some embodiments discussed herein.

FIG. 7 provides a flowchart diagram of an example process for a trained event-based historical interpolation model in accordance with some embodiments discussed herein.

FIG. 8 provides a flowchart diagram of an example process for a trained rule-parameterized criteria satisfaction model in accordance with some embodiments discussed herein.

FIG. 9 provides a flowchart diagram of an example process for a trained prospective cost prediction model in accordance with some embodiments discussed herein.

FIG. 10 provides a flowchart diagram of an example process for a trained criteria satisfaction model in accordance with some embodiments discussed herein.

FIG. 11 provides a flowchart diagram of an example process for a trained prospective cost prediction model in accordance with some embodiments discussed herein.

FIG. 12 provides an operational example of predictive input channels and corresponding models which may be used for coordination of benefits in accordance with some embodiments discussed herein.

FIG. 13 provides an operational example for performing prospective prioritization in accordance with some embodiments discussed herein

FIG. 14 provides an operation example of a user interface depicting prospective prioritization data in accordance with some embodiments discussed herein.

### DETAILED DESCRIPTION

Various embodiments of the present invention are described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. Overview

Various embodiments of the present invention disclose techniques for more efficiently and reliably performing data prioritization across a plurality of predictive input channels. For example, various embodiments of the present invention disclose techniques for performing data prioritization that utilize one or more supervised machine learning models. The inventors have confirmed, via experiments and theoretical calculations, that various embodiments of the disclosed techniques improve efficiency and accuracy of prospective prioritization relative to various state-of-the-art solutions.

By facilitating efficient and reliable data prioritization, various embodiments of the present invention improve data retrieval efficiency as well as data storage efficiency of various data storage systems. Aggregating data from a plurality of channels into a single prioritized channel facilitates more efficient storage of such data, for example by enabling consolidation of data across various databases and/or across various database tables. This in turn reduces storage needs of various existing data storage systems. Furthermore, performing prospective prioritization across channels enables faster and more reliable retrieval of the most significant portions of data in response to data queries. This in turn increases the efficiency and reliability of data retrieval operations and/or data query processing operations across various data storage systems, such as various data storage systems that act as a server devices in client-server data storage architectures.

Accordingly, by utilizing some or all of the innovative techniques disclosed herein for performing prospective prioritization across a plurality of predictive input channels, various embodiments of the present invention increase efficiency and accuracy of data storage operations, data retrieval operations, and/or query processing operations across various data storage systems, such as various data storage systems that are part of client-server data storage architectures. In doing so, various embodiments of the present invention make substantial technical contributions to the field of database systems and substantially improve state-of-the-art data storage systems.

### II. Definitions of Certain Terms

The term “predictive input entity” may refer to a data object describing an entity in relation to which one or more predictive tasks are performed. In some example embodiments, the data object may describe a member who receives healthcare services or products (or any other type of service or product) rendered by a provider and/or who relies on financing from a health insurance insurer to cover the costs of the rendered health services or products. A member may be associated with the health insurance insurer and may be considered a member of a program associated with the health insurance insurer.

The term “prospective triggering event occurrence” may refer to a data object describing an event which triggers an interest with respect to a predictive input entity. In some example embodiments, the data object may describe a request for payment/reimbursement for services rendered, materials used, equipment provided, and/or the like (e.g., a claim filing). In various embodiments, a claim may be a request for payment/reimbursement for a consultation with a primary care doctor, a medical procedure or an evaluation performed by an orthopedic surgeon, a laboratory test performed by a laboratory, a surgery, durable medical equipment provided to an injured member, medications or other materials used in the treatment of a member, and/or the like.

The term “predictive input channel” may refer to an inventory of data objects describing and/or corresponding with a plurality of predictive input entities (e.g., data objects describing members, member records/profiles, member identifiers and/or the like). Each data object may store/represent feature data associated with a predictive input entity. The inventory of a predictive input channel may be generated based on probabilistic models and/or deterministic rules. The inventory of the predictive input channel may be generated responsive to one or more events which trigger an interest with respect to a predictive input entity (e.g., real-time events, triggering event occurrences and/or the like) or may be prospective (e.g., based on historical triggering event data). A predictive input channel may be configured to determine (e.g., prioritize, classify, select, organize, arrange and/or the like) predictive input entities based on feature data (e.g., member information and/or data and or the like).

The term “model-based prospective channel” may refer to a predictive input channel in which inventory is generated based on a probabilistic model that may be trained on historic data associated with a plurality of predictive input entities. For example, the inventory of the model-based prospective channel may be generated based on feature data (e.g., member information/data) associated with a plurality of predictive input entities.

The term “rule-based prospective channel” may refer to a predictive input channel in which inventory is generated by applying one or more deterministic rules (e.g., rules associated with feature data of a plurality of predictive input entities). The inventory of a rule-based prospective channel may be based on feature data (e.g., member information/data) associated with the predictive input entities.

The term “model-based real-time channel” may refer to a predictive input channel in which inventory is generated based on a probabilistic model that may be trained on historic data associated with a plurality of predictive input entities. For example, the inventory of the model-based real-time channel may be generated responsive to one or more events which trigger an interest with respect to a predictive input entity (e.g., real-time events, triggering event occurrences and/or the like).

The term “rule-based real-time channel” may refer to a predictive input channel in which inventory is generated by applying one or more deterministic rules (e.g., rules associated with feature data of a plurality of predictive input entities. For example, the inventory of the rule-based real-time may be generated in response to one or more events which trigger an interest with respect to a predictive input entity (e.g., real-time events, triggering event occurrences and/or the like).

The term “prospective triggering event occurrence predictive output” may refer to a data object indicating a likelihood of an event which triggers an interest with respect to a predictive input entity. The prospective triggering event occurrence predictive output may be determined using a trained event-based historical interpolation model configured to process per-entity historical triggering event data associated with a predictive input entity to generate a hypothesis for determining the prospective triggering event occurrence predictive output with respect to the predictive input entity. For example, the prospective triggering event occurrence may be a claim filing prediction with respect to a predictive input entity within a period of time (e.g., the next three months or six months). The data object may store/describe historical triggering event data associated with the predictive input entity. The historical triggering event data may comprise feature data (e.g., claim data and/or member information/data) corresponding with the likelihood of the prospective triggering event occurrence. For example, claim data may refer to a number of or frequency of historical triggering event occurrences (e.g., doctor visits, hospital stays and/or the like). Member information/data may include disease profiles, chronic conditions and/or the like. Feature data having certain characteristics may indicate a higher likelihood of a prospective triggering event occurrence (e.g., likelihood of a claim filing). The prospective triggering event occurrence predictive output may be determined based at least in part on a supervised machine learning model (e.g., a neural network machine learning model). In some embodiments, the supervised machine learning model may utilize machine learning algorithms such as support vector machines, linear regression, logistic regression, naïve Bayes classifiers, decision trees and the like.

The term “prospective qualifying criteria satisfaction predictive output” may refer to a data object describing a level of interest with respect to an event which triggers an interest with respect to a predictive input entity. For example, the prospective qualifying criteria satisfaction predictive output may represent a likelihood that feature data associated with the predictive input entity satisfies one or more criteria or rule effectiveness parameters. The criteria and/or rule effectiveness parameters may be based at least in part on historic rule effectiveness data. In some embodiments, if an event which triggers an interest with respect to a predictive input entity occurs, the level of interest may be deemed certain/absolute. In some embodiments, the data object may store/describe criteria-related feature data associated with a predictive input entity. For example, criteria-related feature data may comprise demographic data satisfying one or more rules associated with a predictive input entity (e.g., a person over the age of 65, a person located in Georgia, a person who is married, a person who is employed and/or the like.) Some criteria-related feature data may be indicative of a high level of interest with respect to an event which triggers an interest with respect to a predictive input entity. For example, in the context of a coordination of benefits scenario, the prospective qualifying criteria satisfaction predictive output may be a likelihood that a given member is eligible for insurance coverage through another insurer. In that context, a member that is married may be more likely to have additional insurance. One or more criterion/rule effectiveness parameters may be used to generate the prospective qualifying criteria satisfaction predictive output with respect to each predictive input entity. In some embodiments, the prospective qualifying criteria satisfaction predictive output may be determined using a trained rule-parameterized criteria satisfaction model which is configured to process per-entity criteria related feature data associated with a predictive input entity in accordance with one or more model parameters comprising one or more rule effectiveness parameters.

The term “prospective cost predictive output” may refer to a data object describing a magnitude prediction corresponding with an event which triggers an interest with respect to a predictive input entity. The magnitude prediction may be an inferred value (e.g., representing a prospective cost prediction) or an actual value (e.g., representing a real value corresponding with an event in real-time). Additionally and/or alternatively, the prospective cost predictive output may represent a cumulative value over time associated with a predictive input entity.

The prospective cost predictive output may comprise a maximal triggering event occurrence prediction value which is the larger value of the inferred prospective cost predictive output and the real-time prospective cost predictive output. The prospective cost predictive output may be determined based at least in part on a supervised machine learning model (e.g., a neural network machine learning model). The supervised machine learning model may be trained on features/feature sets (e.g., historical cost data). In some embodiments, historical cost data may comprise claim features. Example claim features may include a claim ID and the date a claim was received—e.g., Dec. 14, 2013, at 12:00:00 pm and time stamped as 2013-12-14 12:00:00. The claim features may also include one or more diagnostic codes, treatment codes, treatment modifier codes, and/or the like. Such codes may be any code, such as Current Procedural Terminology (CPT) codes, billing codes, Healthcare Common Procedure Coding System (HCPCS) codes, ICD-10-CM Medical Diagnosis Codes, and/or the like. In some embodiments, the supervised machine learning model may utilize machine learning algorithms such as support vector machines, linear regression, logistic regression, naive Bayes classifiers, decision trees and the like. The inferred prospective cost predictive output may be determined using a trained prospective cost prediction model. In some embodiments, a trained prospective cost prediction model may refer to a supervised machine learning model configured to process historical cost data associated with a plurality of predictive input entities to generate a hypothesis for determining a prospective cost predictive output with respect to a predictive input entity.

The term “prospective prioritization system” may refer to system configured to perform predictive tasks (e.g., an event-based cost prediction system) with respect to a plurality of predictive input entities. In some embodiments, the prospective prioritization system may be configured to generate a prospective priority score representing the likelihood of a prospective triggering event occurrence (e.g., a claim filing) with respect to a predictive input entity based on the outputs of a plurality of predictive tasks. In example embodiments, the predictive tasks may include determining a prospective triggering event occurrence predictive output, determining a prospective qualifying criteria satisfaction predictive output, determining a prospective cost predictive output and/or the like. The prospective priority score may comprise an aggregated output of the plurality of predictive tasks. For example, an arithmetic ensemble model aggregating the output of the plurality of predictive tasks may be utilized to generate the prospective priority score. In an example embodiment, the arithmetic ensemble model may comprise a weighted sum. In some embodiments, some of the outputs of the predictive tasks may be substituted with static averages.

In an example embodiment, the prospective triggering event occurrence predictive output, the prospective qualifying criteria satisfaction predictive output and the prospective cost predictive output may be aggregated to generate the prospective priority score in accordance with the following equation: Risk score=(Prospective triggering event occurrence predictive output)×(Prospective qualifying criteria satisfaction predictive output)×(Prospective cost predictive output)

In some embodiments: prospective prioritization system may determine a predictive input channel comprising an inventory of data objects, each data object describing a predictive input entity, and train one or more probabilistic or deterministic machine learning models (e.g., supervised machine learning models) to perform predictive tasks (e.g., the prospective triggering event occurrence predictive output, the prospective qualifying criteria satisfaction predictive output and the prospective cost predictive output). The prospective prioritization system may perform predictive tasks in relation to each predictive input entity in order to determine a prospective priority score for each predictive input entity. The prospective prioritization system may prioritize the inventories of one or more predictive input channels in accordance with to the determined prospective priority scores corresponding with each predictive input entity. The prospective prioritization system may prioritize the inventory in a continuous manner by combining real-time and prospective channels to generate a single prioritized channel and/or one or more queues.

The term “investigation queue” may refer to a data object that describes an ordering of a plurality of data objects describing predictive input entities and corresponding prospective priority scores (e.g., prospective priority scores) based at least in part on a portion of the single prioritized channel. In some embodiments, the prospective prioritization system may be configured to generate one or more API-based data objects corresponding with the single prioritized channel and/or the one or more queues. The prospective prioritization system may provide (e.g., transmit, send) the one or more API-based data objects representing at least a portion of the single prioritized channel and/or the one or more queues to an end user interface (e.g., an investigation agent user interface) for display.

The term “coordination of benefits” may refer to a scenario in which a member of one health insurance company has additional coverage elsewhere. The additional coverage may be with another commercial health insurance company or with a government program (e.g., Medicare or Medicaid). Coordination of benefits enables insurance companies to determine/identify primary insurers, avoid duplicate payments, and reduce the cost of insurance premiums for members.

The term “member record/profile” may refer to a data object storing and/or providing access to member information/data. The member record/profile may also comprise member information/data, member features, and/or similar words used herein interchangeably that can be associated with a given member, claim, and/or the like. In some embodiments, member information/data can include age, gender, poverty rates, known health conditions, home location, profession, access to medical care, medical history, claim history, member identifier (ID), and/or the like. Member information/data may also include marital status, employment status, employment type, socioeconomic information/data (e.g., income information/data), relationship to the primary insured, insurance product information/data, insurance plan information/data, member classifications, language information/data, and/or the like.

The term “member identifier” may refer to a data object configured to uniquely identify/determine the member (e.g., member identifier, user identifier, and/or the like), a username, user contact information/data (e.g., name (John Doe), one or more electronic addresses such as emails, instant message usernames, social media user name, and/or the like), member preferences, member account information/data, member credentials, information/data identifying/determining one or more member computing entities corresponding to the member, and/or the like. As noted, each member record/profile may correspond to a unique username, unique user identifier (e.g., 11111111), access credentials, and/or the like.

The term “investigation agent” may refer to a user (e.g., a human investigation agent) or a programmatic investigation agent (e.g., an artificial intelligence agent). Prospective prioritization may comprise assigning one or more predictive input entities to one of a plurality of investigation agents based on the prospective priority score of the predictive input entity and causing each investigation agent to process a related subset of the plurality of predictive input entities that is associated with the investigation agent. The system may generate an investigation agent user interface for each investigation agent that describes one or more investigation queue features of the related subset associated with the investigation agent. A queue may be assigned to an investigation agent. The user may navigate an investigation agent user interface by operating a user computing entity. Through the investigation agent user interface, the user (e.g., human investigation agent) may view and access claim inventory, claim information/data, member information/data, provider information/data, and/or the like. To do so, the prospective prioritization system may provide access to the system via a user profile that has been previously established and/or stored. In an example embodiment, a user profile comprises user profile information/data, such as a user identifier configured to uniquely identify the user, a username, user contact information/data (e.g., name, one or more electronic addresses such as emails, instant message usernames, social media user name, and/or the like), user preferences, user account information/data, user credentials, information/data identifying one or more user computing entities corresponding to the user, and/or the like.

In various embodiments, the investigation agent may be associated with one or more queues assigned to the corresponding user (e.g., human investigation agent). The queues can be updated continuously, regularly, and/or in response to certain triggers. Moreover, the queues may be any of a variety of data structures that allow for efficient and dynamic prioritization and reprioritization, such as array data structures, heap data structures, map data structures, linked list data structures, tree data structures, and/or the like. Dynamically updating a queue associated with a particular user (e.g., investigation agent) can cause an active investigation agent user interface with which the user is interacting to automatically be updated. In other embodiments, an investigation agent may be an artificial investigation agent, such as artificial intelligence bots that can perform at least some or a subset of the functions of a human investigation agent. In such an embodiment, each artificial investigation agent can be associated with one or more queues and benefit from the techniques and approaches described herein.

### III. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatuses, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. Exemplary System Architecture

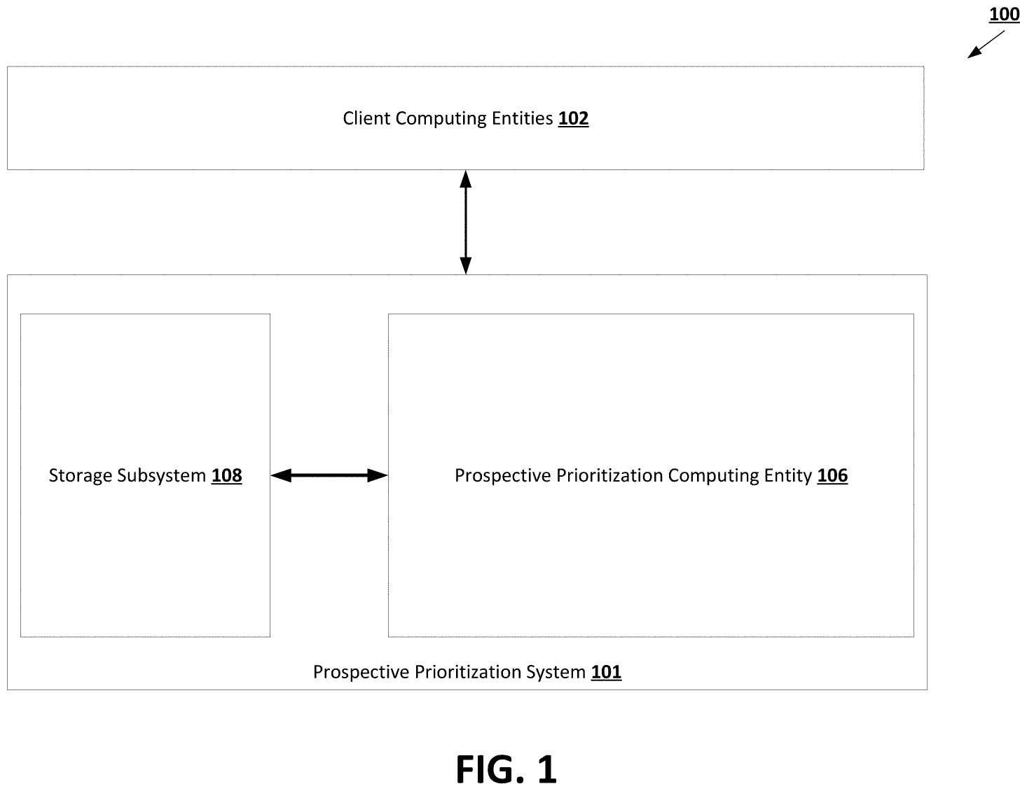

FIG. 1 is a schematic diagram of an example architecture 100 for performing prospective prioritization across a plurality of predictive input channels. The architecture 100 includes a prospective prioritization system 101 configured to receive requests from the client computing entities 102, process the requests to generate query outputs (e.g., predictive outputs) and provide the query outputs to the client computing entities 102. In some embodiments, prospective prioritization system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The prospective prioritization system 101 may include a prospective prioritization computing entity 106 and a storage subsystem 108. The prospective prioritization computing entity 106 may be configured to process the requests to generate query outputs and provide the query outputs to the client computing entities 102. The storage subsystem 108 may be configured to store at least a portion of input data utilized by the prospective prioritization computing entity 106 to perform predictive tasks and prospective prioritization. The storage subsystem 108 may further be configured to store at least a portion of data (e.g., feature data) utilized by the prospective prioritization computing entity 106 to perform automated prospective prioritization.

The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Prospective Prioritization Computing Entity

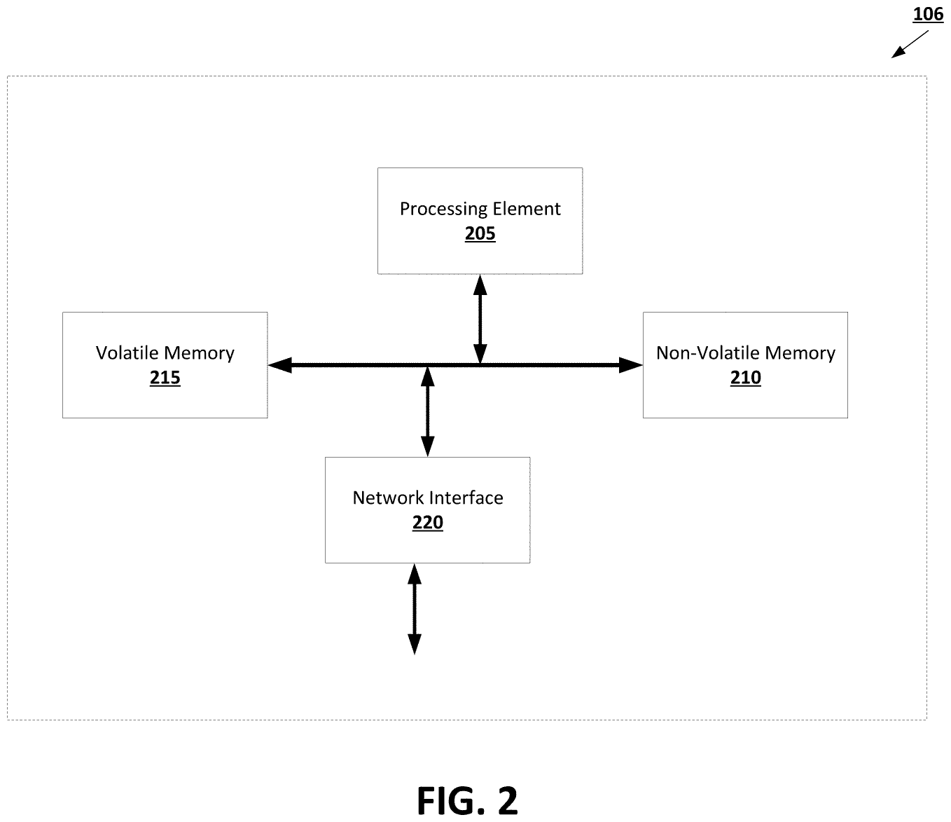

FIG. 2 provides a schematic of a prospective prioritization computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the prospective prioritization computing entity 106 may also include one or more network interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the prospective prioritization computing entity 106 may include or be in communication with one or more processing elements 205 (also referred to as processors, processing circuitry, and/or similar terms used herein interchangeably) that communicate with other elements within the prospective prioritization computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the prospective prioritization computing entity 106 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity—relationship model, object model, document model, semantic model, graph model, and/or the like.

In one embodiment, the prospective prioritization computing entity 106 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the prospective prioritization computing entity 106 with the assistance of the processing element 205 and operating system.

As indicated, in one embodiment, the prospective prioritization computing entity 106 may also include one or more network interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the prospective prioritization computing entity 106 may be configured to communicate via wireless client communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the prospective prioritization computing entity 106 may include or be in communication with one or more input elements, such as a keyboard input, a mouse input, a touch screen/display input, motion input, movement input, audio input, pointing device input, joystick input, keypad input, and/or the like. The prospective prioritization computing entity 106 may also include or be in communication with one or more output elements (not shown), such as audio output, video output, screen/display output, motion output, movement output, and/or the like.

### Exemplary Client Computing Entity

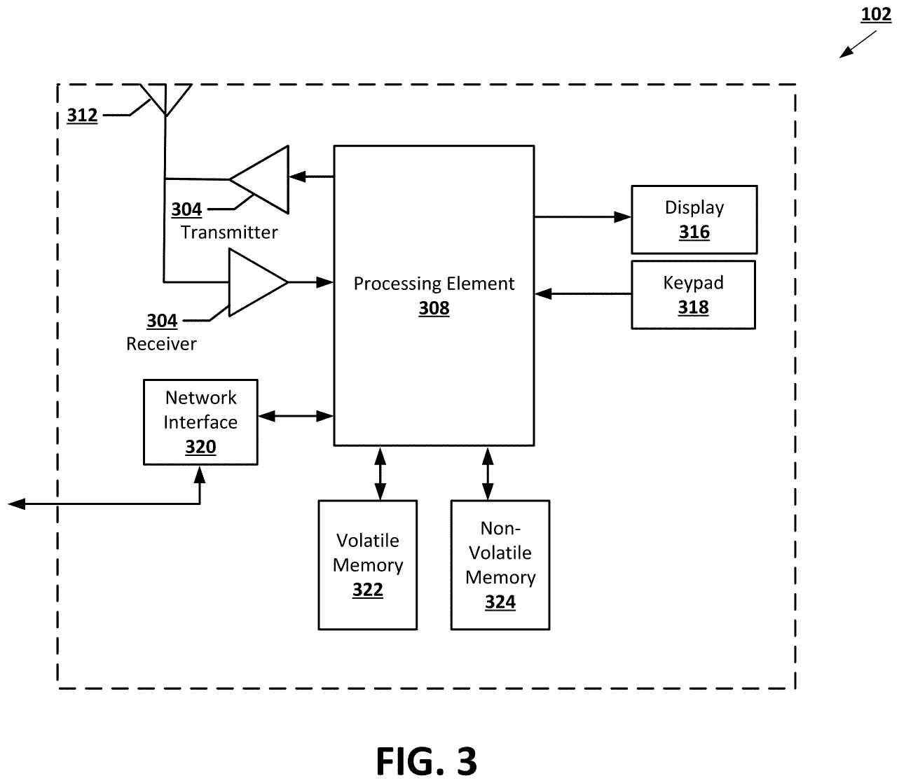

FIG. 3 provides an illustrative schematic representative of a client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the prospective prioritization computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the prospective prioritization computing entity 106 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the prospective prioritization computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FIG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the prospective prioritization computing entity 106 and/or various other computing entities.

In another embodiment, the client computing entity 102 may include one or more components or functionality that are the same or similar to those of the prospective prioritization computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. Exemplary System Operations

Described herein are various techniques for data prioritization across predictive input channels. Some of the disclosed techniques may utilize supervised machine learning models to perform predictive tasks, e.g., generate predictive outputs with respect to each of a plurality of predictive input entities.

Existing systems consist of independently managed predictive input channels in which inventory may be generated based on real-time rules, real-time models, prospective rules or prospective models. Particular combinations of predictive tasks performed using corresponding models are described herein. However, a person of ordinary skill in the art will recognize that data prioritization in relation to a plurality of predictive input entities across predictive input channels may be performed using other combinations and models that are different from the described combinations and models.

By facilitating efficient and reliable prospective prioritization, various embodiments of the present invention improve data retrieval efficiency as well as data storage efficiency of various data storage systems. Generating a single prioritized channel from a plurality of predictive input channels facilitates more efficient storage of data, for example by enabling consolidation of information across various databases and/or across various database tables. This in turn reduces storage needs of various existing data storage systems. Furthermore, prioritization across channels enables faster and more reliable retrieval of data in response to data queries and for further operations. This in turn increases the efficiency and reliability of data retrieval operations and/or data query processing operations across various data storage systems, such as various data storage systems that act as server devices in client-server data storage architectures.

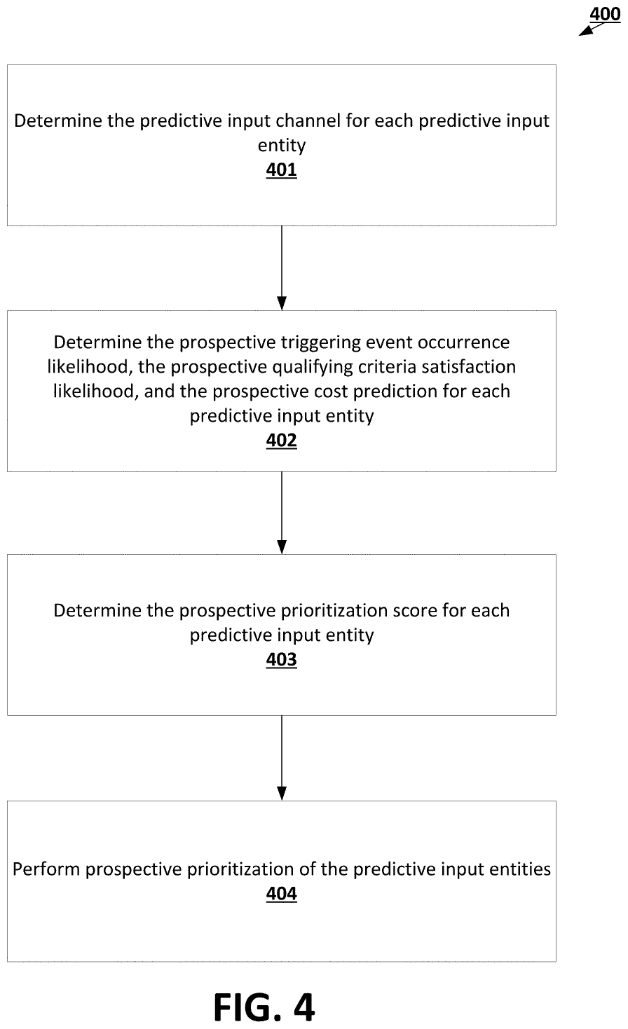

FIG. 4 is a flowchart diagram of an example process 400 for data prioritization across a plurality of predictive input channels. Via the various steps/operations of the process 400, the prospective prioritization computing entity 106 can efficiently and reliably process and aggregate data from the plurality of predictive input channels, determine a prospective prioritization score for each of a plurality of predictive input entities and perform prospective prioritization with respect to the predictive input entities.

### Determining a Predictive Input Channel

The process 400 begins at step/operation 401 when the prospective prioritization computing entity 106 determines a predictive input channel from a plurality of predictive input channels for each predictive input entity. Each predictive input channel may refer to an inventory of data objects describing and/or corresponding with a plurality of predictive input entities. Each data object may store and/or represent feature data associated with a predictive input entity. In some embodiments, predictive input entities may be associated with a claim filing for a member and an example data object may store claim features. Each predictive input channel may be associated with a probabilistic model or one or more deterministic rules. Additionally, the inventory generated therein may be generated in real-time such that the probabilistic models or deterministic rules are applied responsive to events which trigger an interest with respect to a predictive input entity (e.g., real-time events, triggering event occurrences and/or the like). In other embodiments, the inventory may be generated prospectively by applying probabilistic models or deterministic rules in a continuous fashion (e.g., based on historical triggering event data). A predictive input channel may be configured to determine (e.g., prioritize, classify, select, organize, arrange and/or the like) predictive input entities based on feature data.

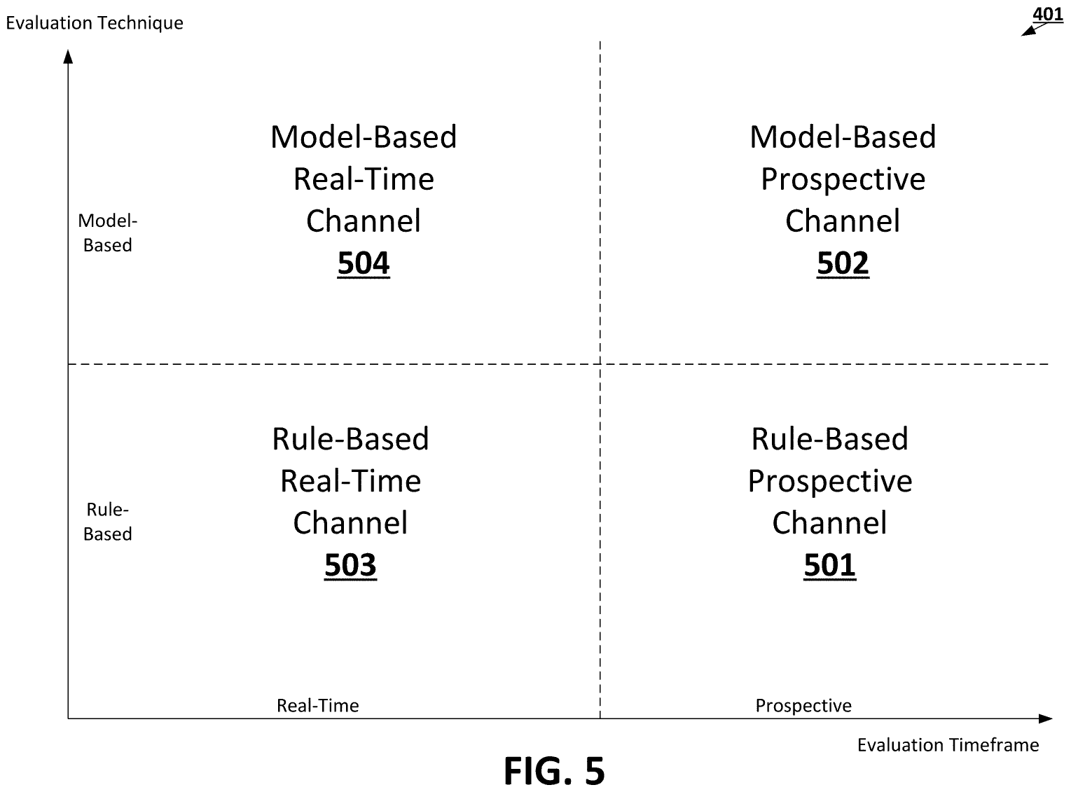

FIG. 5 illustrates a two dimensional organizational diagram illustrating various characteristics of exemplary predictive input channels. Each channel may correspond with a different evaluation technique, illustrated on the y-axis of the diagram, and a different evaluation timeframe, illustrated on the x-axis of the diagram. As shown, the prospective prioritization computing entity 106 can determine one of four types of predictive input channels; a rule-based prospective channel 501, a model-based prospective channel 502, a rule-based real-time channel 503 and a model-based real-time channel 504.

A rule-based prospective channel 501 may correspond with a prospective evaluation timeframe and a rule-based evaluation technique. The rule-based prospective channel 501 may refer to a predictive input channel in which inventory is generated by applying one or more deterministic rules to a plurality of predictive input entities. For example, the deterministic rules may correspond with characteristics that may be present or absent in the feature data (e.g., member information/data) associated with a predictive input entity.

A model-based prospective channel 502 may correspond with a prospective evaluation timeframe and a model-based evaluation technique. The model-based prospective channel 502 may refer to a predictive input channel in which inventory is generated based on a probabilistic model that may be trained on historic data associated with a plurality of predictive input entities. For example, the inventory of the model-based prospective channel 502 may be generated based on historical information/data associated with a plurality of predictive input entities.

A rule-based real-time channel 503 may correspond with a real-time evaluation timeframe and a rule-based evaluation technique. The rule-based real-time channel 503 may also refer to a predictive input channel in which inventory is generated by applying one or more deterministic rules to a plurality of predictive input entities. For example, the deterministic rules may correspond with characteristics that may be present or absent in the feature data (e.g., member information/data) associated with a predictive input entity. Additionally, the inventory of the rule-based real-time channel 503 may be generated in response to one or more events which trigger an interest with respect to a predictive input entity (e.g., real-time events, triggering event occurrences and/or the like).

A model-based real-time channel 504 may correspond with a real-time evaluation timeframe and a model-based evaluation technique. The model-based real time channel 504 may also refer to a predictive input channel in which inventory is generated based on a probabilistic model that may be trained on historic data associated with a plurality of predictive input entities. For example, the inventory of the model-based real-time channel 504 may be generated based on historical information/data associated with a plurality of predictive input entities. Additionally, the inventory of the model-based real-time channel 504 may be generated in response to one or more events which trigger an interest with respect to a predictive input entity (e.g., real-time events, triggering event occurrences and/or the like).

### Performing Predictive Tasks

In various embodiments, upon determining a predictive input channel for a predictive input entity, the prospective prioritization computing entity 106 may perform predictive tasks with respect to the predictive input entity to generate one or more predictive outputs with respect to the predictive input entity. Returning to FIG. 4, at step/operation 402, in an example embodiment, the prospective prioritization computing entity 106 may determine at least one of a prospective triggering event occurrence predictive output, a prospective qualifying criteria satisfaction predictive output and a prospective cost predictive output with respect to each predictive input entity.

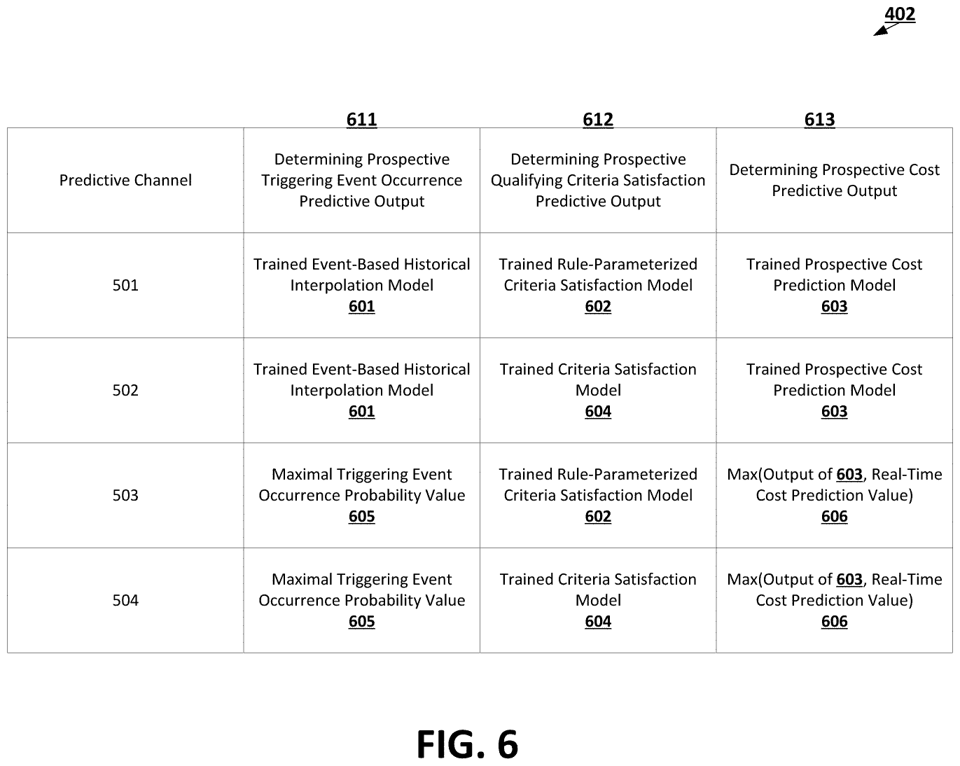

The prospective prioritization computing entity 106 may be configured to utilize one of a plurality of models to perform predictive tasks with respect to each predictive input entity. The designated model for a predictive task may correspond with the type of predictive input channel associated with the predictive input entity. Referring to FIG. 6, for each predictive input channel and for each desired predictive output (and thus, for each corresponding predictive input entity), one of a plurality of corresponding models may be mapped to the predictive input channel for generating each predictive output. As shown, each predictive input channel 501, 502, 503, 504 is designated a particular model to perform the predictive tasks in order to generate each predictive output 611, 612, 613 with respect to each predictive input entity. The models may comprise supervised (i.e., trained) machine learning models (e.g., neural network machine learning models) configured to perform predictive tasks and generate predictive outputs. An exemplary machine learning model may generate a predictive output based on a machine learning algorithm/hypothesis function trained on feature subsets which are correlations extracted from feature data (e.g., predictive input entity characteristic data or historical event data associated with a predictive input entity). The correlations may be used to determine weight values for one or more variables of the hypothesis function. The exemplary machine learning model may use machine learning algorithms such as support vector machines, linear regression, logistic regression, naive Bayes classifiers, decision trees and the like to determine one or more weight values for each variable of the hypothesis function.

The prospective prioritization computing entity 106 may aggregate one or more sets of training data to train each machine learning model. To train a supervised machine learning model, a training engine of the prospective prioritization computing entity 106 may select feature subsets from feature data corresponding with predictive input entities for the purposes of a training iteration. The training engine may then process the feature subsets to determine an inferred related subset. Thereafter, the training engine may compare the inferred related subset to the feature subsets in order to generate an error function for the supervised machine learning model. The error function may indicate a difference between a feature subset (i.e., actual output extracted from the feature data) and an inferred related subset (i.e., predictive output generated by the machine learning model). The supervised machine learning model may optimize the one or more weight values of the hypothesis function in order to optimize for predictions with the smallest measure of error between the feature subsets and the inferred related subset. The prospective prioritization computing entity 106 may run one or more training iterations in order to update the one or more weight values to optimize the measure of error. Various types of supervised machine learning models and training algorithms may be used, such as a gradient descent training algorithm. However each machine learning model will differ with regard to which feature subsets/training sets it utilizes. For example, with reference to FIG. 6, a trained event-based historical interpolation model 601 may use historical triggering event data to determine feature subsets/training sets, whereas a trained rule-parameterized criteria satisfaction model 602 may use criteria-related feature data to determine feature subsets/training sets.

In various embodiments, the prospective prioritization computing entity 106 may determine a prospective triggering event occurrence predictive output 611 with respect to a predictive input entity. The prospective triggering event occurrence predictive output 611 may refer to a data object indicating a likelihood of an event which triggers an interest with respect to a predictive input entity.

In some embodiments, as illustrated in FIG. 6, the prospective prioritization computing entity 106 may utilize a trained event-based historical interpolation model 601 to determine a prospective triggering event occurrence predictive output 611 with respect to a predictive input entity associated with a rule-based prospective channel 501 or a model-based prospective channel 502. The trained event-based historical interpolation model may be a supervised machine learning model (e.g., a neural network machine learning model). The supervised machine learning model may utilize machine learning algorithms such as support vector machines, linear regression, logistic regression, naive Bayes classifiers, decision trees and the like.

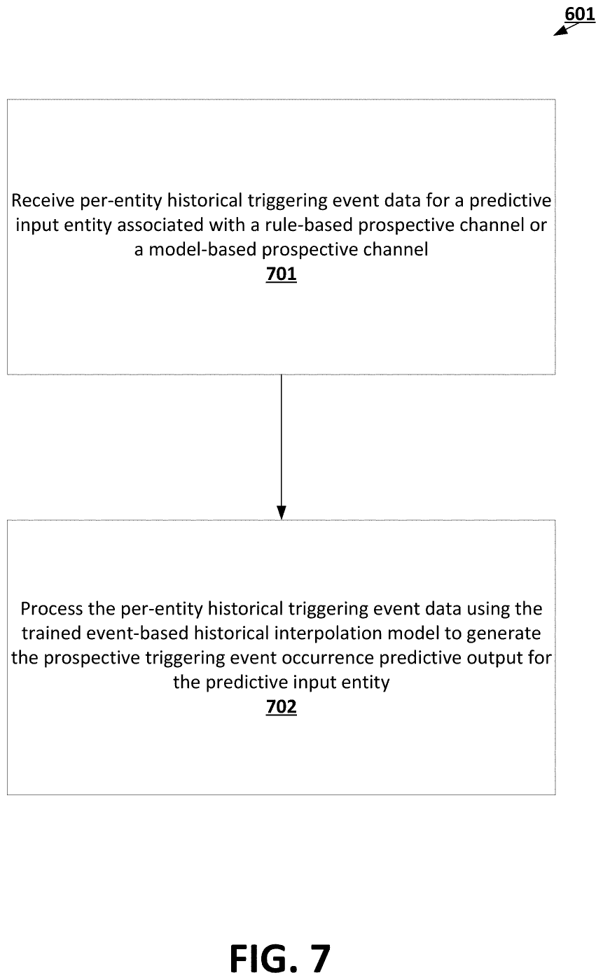

FIG. 7 provides a flowchart diagram of an example process for a trained event-based historical interpolation model 601 in accordance with some embodiments. Beginning at step/operation 701, prospective prioritization computing entity 106 receives per-entity historical triggering event data associated with a predictive input entity associated with a rule-based prospective channel 501 or model-based prospective channel 502. Per-entity historical triggering event data may refer to feature data associated with a predictive input entity which corresponds with previous triggering event occurrences with respect to the predictive input entity and may include an indication of a frequency of the previous triggering event occurrences and/or characteristics corresponding with the frequency of previous triggering event occurrences.

At step/operation 702, prospective prioritization computing entity 106 processes the per-entity historical triggering event data to generate the prospective triggering event occurrence predictive output 611 with respect to the predictive input entity. For example, the trained event-based historical interpolation model 601 may utilize a trained machine learning algorithm, trained on historical triggering event data feature subsets to generate the prospective triggering event occurrence predictive output 611. In some embodiments, the historical triggering event data may comprise claim data and/or member information/data corresponding with the likelihood of the prospective triggering event occurrence. Claim data may include doctor visits hospital stays and/or the like. Member information/data may include disease profiles, chronic condition and/or the like.

The prospective prioritization computing entity 106 may use a maximal triggering event occurrence probability value 605 with respect to a predictive input entity associated with a rule-based real-time channel 503 or a model-based real-time channel 504. With respect to a real-time channel 503, 504, the maximal triggering event occurrence probability value 605 may be a numeric value corresponding with a triggering event occurrence. For example, the maximal triggering event occurrence probability value 605 may be deemed absolute/certain (e.g., “1”) in the event of a triggering event occurrence.

In various embodiments, the prospective prioritization computing entity 106 may determine a prospective qualifying criteria satisfaction predictive output 612 with respect to a predictive input entity. The prospective qualifying condition satisfaction predictive output 612 may refer to a data object indicating a likelihood describing a level of interest with respect to an event which triggers an interest with respect to a predictive input entity.

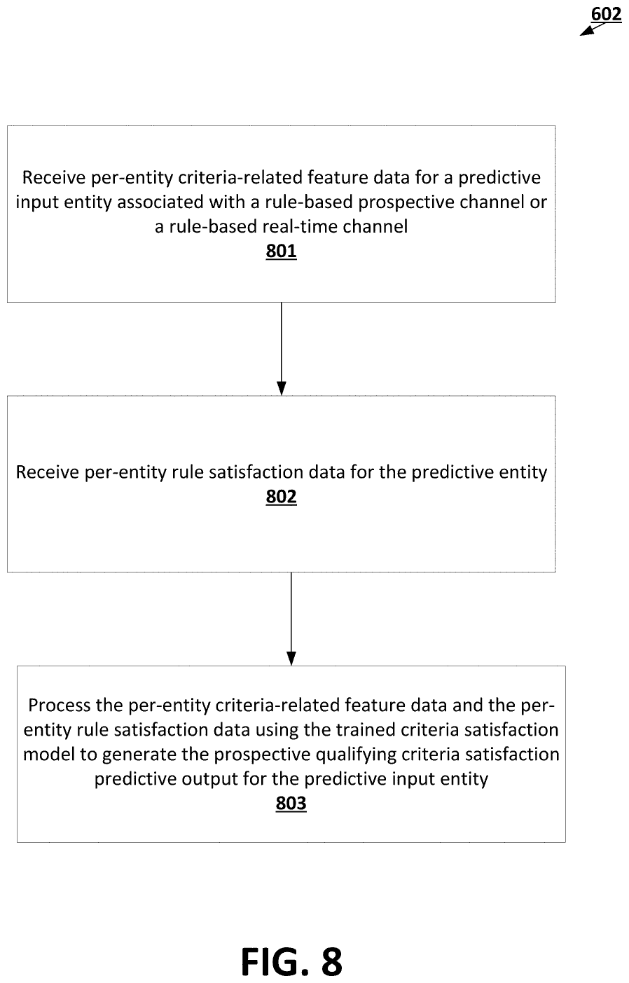

In some embodiments, as illustrated in FIG. 8, the prospective prioritization computing entity 106 may utilize a trained rule-parameterized criteria satisfaction model 602 to determine a prospective qualifying criteria satisfaction predictive output 612 with respect to a predictive input entity associated with a rule-based prospective channel 501 or a rule-based real-time channel 503. The trained rule-parameterized criteria satisfaction model 602 may be a supervised machine learning model (e.g., a neural network machine learning model). The supervised machine learning model may utilize machine learning algorithms such as support vector machines, linear regression, logistic regression, naive Bayes classifiers, decision trees and the like.

FIG. 8. provides a flowchart diagram of an example process for a trained rule-parameterized criteria satisfaction model 602. Beginning at step/operation 801, the prospective prioritization computing entity 106 receives per-entity criteria-related feature data for a predictive input entity associated with a rule-based prospective channel 501 or a rule-based real-time channel 503. Per-entity criteria-related feature data may refer to feature data associated with a predictive input entity which satisfies one or more rules/model parameters. The model parameters may include one or more rule effectiveness parameters, whereby parameters are weighted based on their previous performance. A rule effectiveness parameter may refer to the likelihood that a data object is indicative of a true positive or a false positive, based on previous performance of the rule. Criteria-related feature data may comprise feature data and/or demographic data (e.g., age, gender, poverty rates, known health conditions, home location, profession medical history, claim history, member identifier and/or the like).

At step/operation 802, the prospective prioritization computing entity 106 receives per-entity rule satisfaction data for the predictive input entity. Rule satisfaction data may refer to one or more rules associated with a high likelihood of a true positive based on previous performance of the one or more rules.

At step/operation 803, the prospective prioritization computing entity 106 processes the per-entity criteria-related feature data and the per-entity rule satisfaction data using the trained rule-parameterized criteria satisfaction model 602 to generate the prospective qualifying criteria satisfaction predictive output 612.

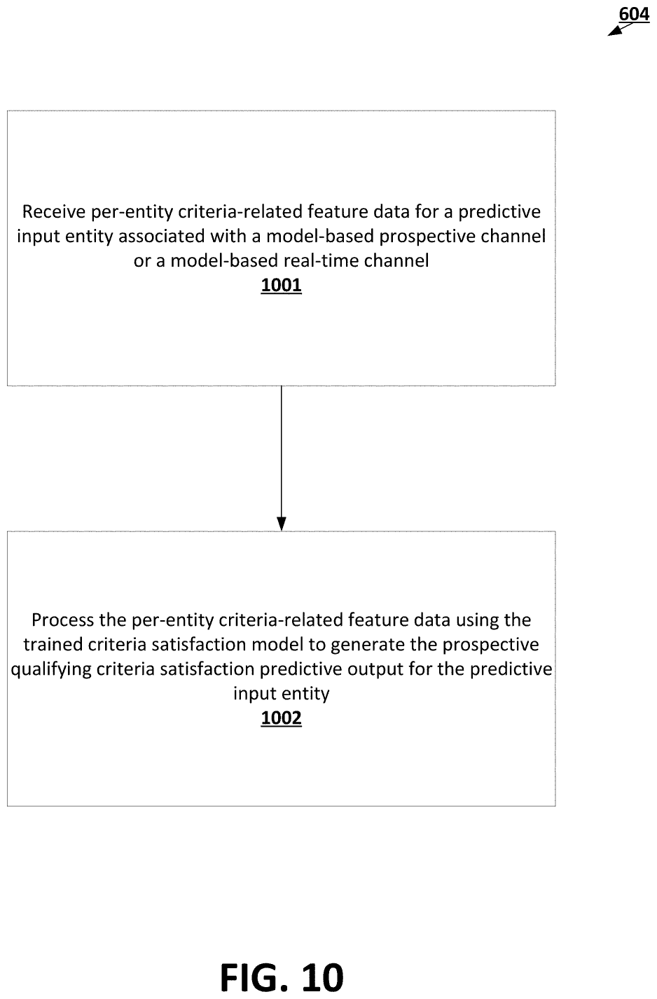

In some embodiments, as illustrated in FIG. 10, the prospective prioritization computing entity 106 may utilize a trained criteria satisfaction model 604 to determine a prospective qualifying criteria satisfaction predictive output 612 with respect to a predictive input entity associated with a model-based prospective channel 502 or a model-based real-time channel 504. The trained criteria satisfaction model 604 may be a supervised machine learning model (e.g., a neural network machine learning model). The supervised machine learning model may utilize machine learning algorithms such as support vector machines, linear regression, logistic regression, naive Bayes classifiers, decision trees and the like.

FIG. 10 provides a flowchart diagram of an example process for a trained criteria satisfaction model 604. Beginning at step/operation 1001, the prospective prioritization computing entity 106 receives per-entity criteria-related feature data for a predictive input entity associated with a model-based prospective channel 502 or a model-based real-time channel 504. As described above in relation to the trained rule-parameterized criteria satisfaction model 602, per-entity criteria-related feature data may refer to feature data associated with a predictive input entity which satisfies one or more rules/model parameters. Criteria-related feature data may include feature data and/or demographic data (e.g., age, gender, poverty rates, known health conditions, home location, profession medical history, claim history, member identifier and/or the like).

At step/operation 1002, the prospective prioritization computing entity 106 processes the per-entity criteria-related feature data using the trained criteria satisfaction model 604 to determine the prospective qualifying criteria satisfaction predictive output 612.

In various embodiments, the prospective prioritization computing entity 106 may determine a prospective cost predictive output 613 with respect to a predictive input entity. The prospective cost predictive output 613 may be a magnitude predictive output (e.g., monetary amount) corresponding with an event which triggers an interest with respect to a predictive input entity.

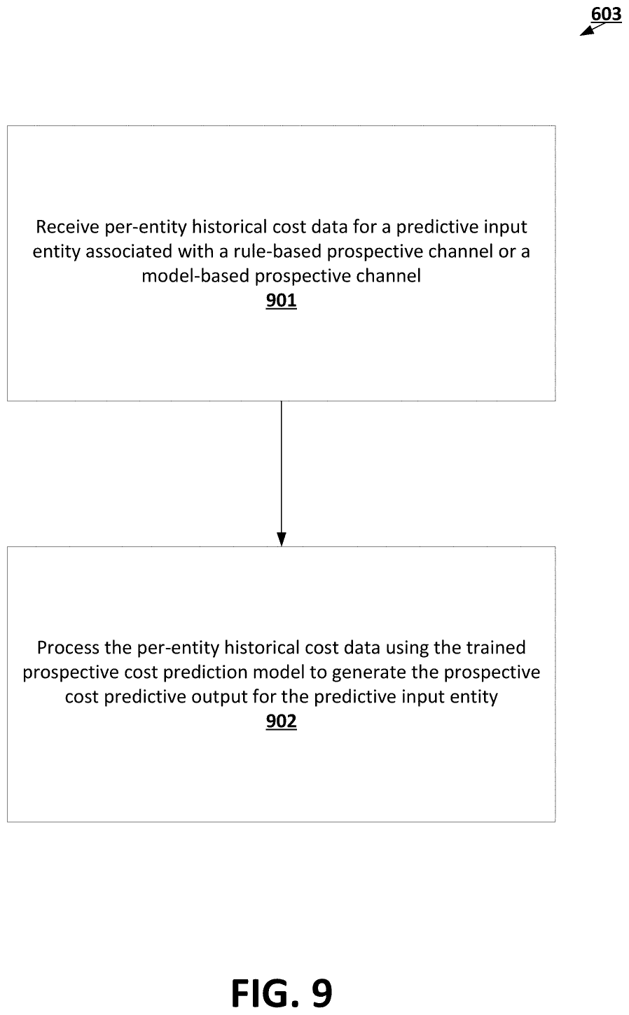

In some embodiments, as illustrated in FIG. 9, the prospective prioritization computing entity 106 may utilize a trained prospective cost prediction model 603 to determine a prospective cost predictive output 613 with respect to a predictive input entity associated with a rule-based prospective channel 501 or a model-based prospective channel 502. The trained prospective cost prediction model 603 may be a supervised machine learning model (e.g., a neural network machine learning model). The supervised machine learning model may utilize machine learning algorithms such as support vector machines, linear regression, logistic regression, naive Bayes classifiers, decision trees and the like.

FIG. 9 provides a flowchart diagram of an example process for a trained prospective cost prediction model 603. Beginning at step/operation 901, the prospective prioritization computing entity 106 receives per-entity historical cost data for a predictive input entity associated with a rule-based prospective channel 501 or a model-based prospective channel 502. Per-entity historical cost data may refer to a data object describing claim features. Example claim features may include a claim amount or value or a cumulative claim cost with respect to a predictive input entity.

At step/operation 902, the prospective prioritization computing entity 106 processes the per-entity historical cost data using the trained prospective cost prediction model 603 to generate the prospective cost predictive output 613.

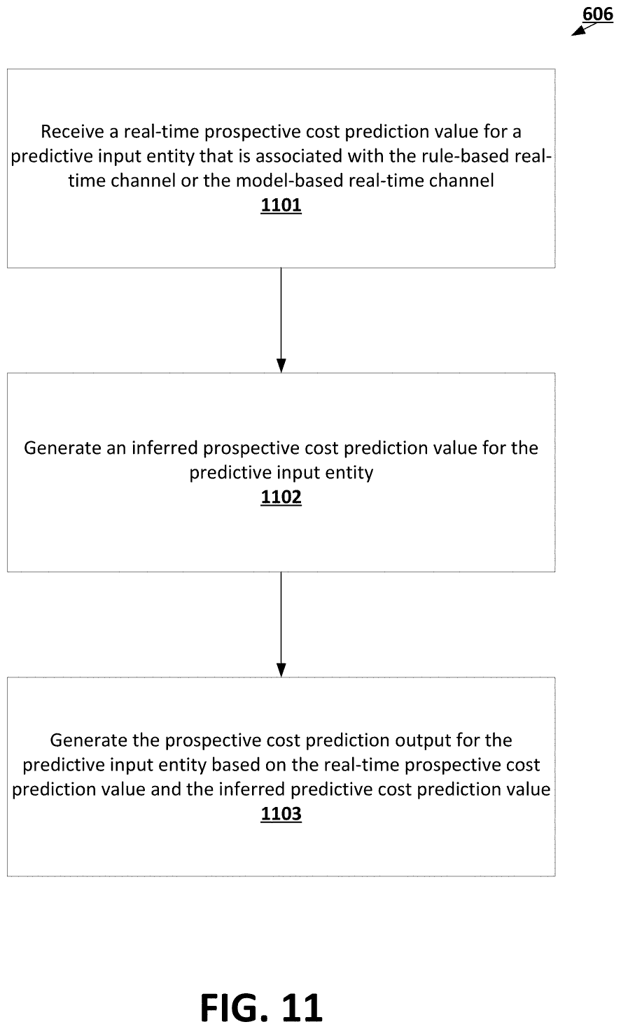

In some embodiments, as illustrated in FIG. 11, the prospective prioritization computing entity 106 may utilize a maximal triggering event occurrence predictive value 606 as the prospective cost predictive output 613 with respect to a predictive input entity associated with a rule-based real-time channel 503 or a model-based real-time channel 504. The maximal triggering event occurrence prediction value 606 may be the larger of an inferred predictive value (e.g., generated using a trained prospective cost prediction model 603) and an actual value corresponding with a triggering event occurrence, such that the actual value may be substituted for the inferred predication value responsive to real-time triggers/events.

FIG. 11 provides a flowchart diagram of an example process for a maximal triggering event occurrence predictive value 606. Beginning at step/operation 1101, the prospective prioritization computing entity 106 receives a real-time prospective cost predictive output value (i.e., corresponding with an actual value) for a predictive input entity that is associated with the rule-based real-time channel 503 or the model-based real-time channel 504.

At step/operation 1102, the prospective prioritization computing entity 106 generates an inferred prospective cost predictive output value for the predictive input entity. Then, at step/operation 1103, the prospective prioritization computing entity 106 generates the prospective cost predictive output 613 which is the larger of the real-time prospective cost predictive output value and the inferred prospective cost predictive output value.

### Determining a Prospective Prioritization Score

Returning to FIG. 4, at step/operation 403, the prospective prioritization computing entity 106 determines a prospective prioritization score (e.g., prospective priority score) for each predictive input entity. The prospective prioritization score may be based at least in part on the predictive outputs of a one or more predictive tasks. For example, the prospective prioritization score may be based at least in part on one or more of the prospective qualifying criteria satisfaction predictive output 612, the prospective triggering event occurrence predictive output 611 and the prospective cost predictive output 613 determined at step/operation 402. In some embodiments, an arithmetic ensemble model aggregating the output of the plurality of predictive tasks may be utilized to generate the prospective prioritization score. In an example embodiment, the arithmetic ensemble model may comprise a weighted sum. In some embodiments, some of the outputs of the predictive tasks may be substituted with static averages.

In some embodiments, determining the prospective prioritization score may include performing the operations described by the below equation:

S=(P1*α1)*(P2*α2)*(P3*α3) Equation 1

In Equation 1:
S is the prospective prioritization score for a predictive input entity,
P₁ is the prospective criteria satisfaction predictive output for the predictive input entity,
P₂ is the prospective triggering event occurrence predictive output for the predictive input entity,
P₃ is the prospective cost predictive output for the predictive input entity,
a₁ is the nominal weight value for the prospective triggering event occurrence predictive output P₁,
a₂ is the nominal weight value for the prospective triggering event occurrence predictive output P₂, and
a₃ is the nominal weight value for the prospective cost predictive output P₃.

In some embodiments, the prospective prioritization computing entity 106 may determine coordination of benefits with respect to predictive input entities. Coordination of benefits may refer to a scenario in which a member of one health insurance company has additional coverage elsewhere. The additional coverage may be with another commercial health insurance company or with a government program (e.g., Medicare or Medicaid). Coordination of benefits enables insurance companies to determine/identify primary insurers, avoid duplicate payments, and reduce the cost of insurance premiums for members.

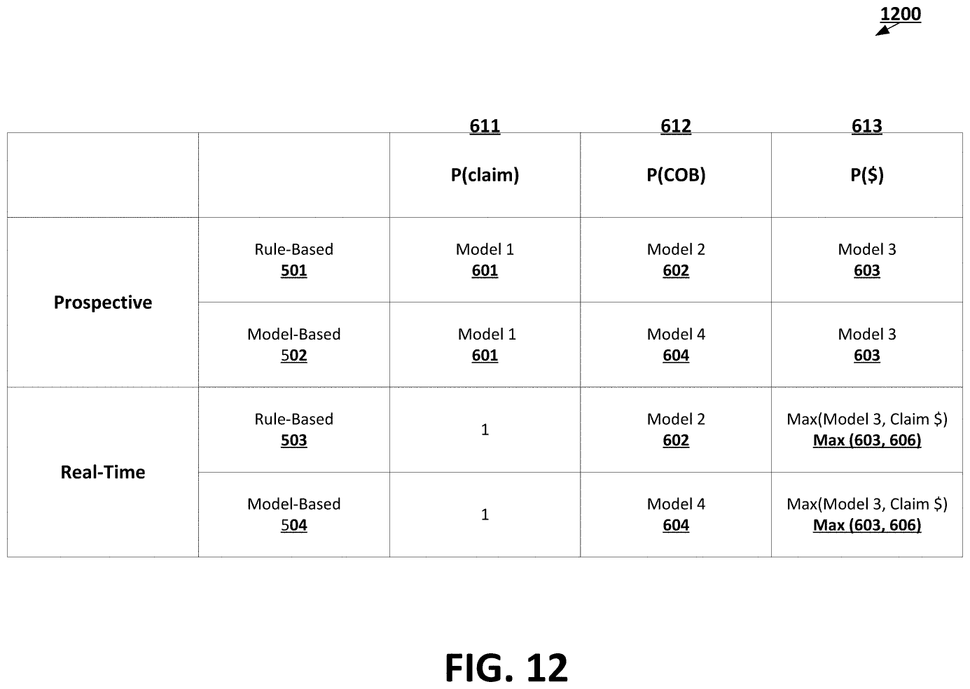

FIG. 12 provides an operational example illustrating predictive input channels and corresponding models which may be used for coordination of benefits. As shown, each type of predictive input channel 501, 502, 503, 504 is associated with a corresponding model or rule. The prospective prioritization computing entity 106 may utilize the models and rules to determine a likelihood of a claim filing (prospective triggering event occurrence predictive output 611), a likelihood of a coordination of benefits scenario (prospective qualifying criteria satisfaction predictive output 612) and a predicted claim amount (prospective cost predictive output 613) with respect to each predictive input entity.

As illustrated, a rule-based prospective channel 501 or a model-based prospective channel may use a trained event-based historical interpolation model 601 (Model 1) to determine the prospective triggering event occurrence predictive output 611 (e.g., likelihood of a claim filing in the next 3 or 6 months) based on historical triggering event data (e.g., medical history/claim features) associated with the predictive input entity (e.g., number of claims, dates of claims, disease profile history and the like). Example claim features may include the date a claim was received—e.g., Dec. 14, 2013, at 12:00:00 pm and time stamped as 2013-12-14 12:00:00. The claim features may also include one or more diagnostic codes, treatment codes, treatment modifier codes, and/or the like. Such codes may be any code, such as Current Procedural Terminology (CPT) codes, billing codes, Healthcare Common Procedure Coding System (HCPCS) codes, ICD-10-CM Medical Diagnosis Codes, and/or the like.

As shown, a rule-based prospective channel 501 or a rule-based real-time channel 503 may use a trained rule-parameterized criteria satisfaction model 602 (Model 2) to determine the prospective qualifying criteria satisfaction predictive output 612 (e.g., likelihood of a coordination of benefits scenario) based on feature data (e.g., demographic data) associated with the predictive input entities (e.g., age, state of residence, marital status, employment status and the like). The trained rule-parameterized criteria satisfaction model 602 (Model 2) may be trained on the outcome of previous investigations where inventory is generated in accordance with one or more deterministic rules. Each deterministic rule corresponds with a baseline false positive rate, for example a deterministic rule may have a false positive rate of 80%. Thus, historic rule performance is the dominant feature in Model 2. However additional feature data (e.g., member information/data) may be used to improve the predictive outputs of the model.

As shown, a model-based prospective channel 502 or a model-based real-time channel 504 may use a trained criteria satisfaction model 604 (Model 4) to determine the prospective qualifying criteria satisfaction predictive output 612 (e.g., likelihood of a coordination of benefits scenario) based on feature data (e.g., demographic data) associated with the predictive input entities (e.g., age, state of residence, marital status, employment status and the like) and corresponding with the outputs of prior coordination of benefits investigations.

For a rule-based real-time channel 503 or a model-based real-time channel 504, the prospective triggering event occurrence predictive output 611 may be a maximal triggering event occurrence probability value (i.e., 1) corresponding with a triggering event occurrence (e.g., a claim filing).

As shown, a rule-based prospective channel 501 or a model-based prospective channel 502 may use a trained prospective cost prediction model 603 (Model 3) to determine the prospective cost predictive output 613 (e.g., predicted claim amount) based on claim features/claim history. For a real-time rule-based channel 503 or a real-time model-based channel 504, the prospective cost predictive output 613 may be the larger of the output of a trained prospective cost prediction model 603 and a real-time cost prediction value, such that the prospective cost predictive output 613 is substituted with an actual claim filing amount/value.

### Performing Prospective Prioritization

Returning to FIG. 4, step/operation 404, the prospective prioritization computing entity 106 may perform prospective prioritization of the predictive input entities. By determining prospective prioritization scores for each of the predictive input entities in a continuous manner (i.e., for predictive input entities associated with prospective channels 501, 502 and real-time channels 503, 504) a single prioritized channel/associated workflow and or one or more queues may be generated for presentation to an end user.

A queue may refer to an ordering of a plurality of data objects describing predictive input entities and corresponding prospective prioritization scores (e.g., prospective priority scores) based at least in part on a portion of the single prioritized channel. In some embodiments, the prospective prioritization system may be configured to generate one or more API-based data objects corresponding with the single prioritized channel and/or the one or more queues. The prospective prioritization system may provide (e.g., transmit, send) the one or more API-based data objects representing at least a portion of the single prioritized channel and/or the one or more queues to an end user interface (e.g., an investigation agent user interface) for display and/or further operations.

The prospective prioritization scores and predictive outputs may be used to dynamically update the user interface (e.g., an investigation agent user interface), generate alerts, for load balancing operations or determining a distribution of resources with respect to inventory (e.g., assigning portions of inventory or data subsets to a plurality of investigative agents). An investigation agent may refer to a user (e.g., human investigation agent) or a programmatic investigation agent (e.g., artificial intelligence agent). Prospective prioritization may comprise assigning one or more predictive input entities to one of a plurality of investigation agents based on the prospective priority score of the predictive input entity and causing each investigation agent to process a related subset of the plurality of predictive input entities that is associated with the investigation agent. The system may generate an investigation agent user interface for each investigation agent that describes one or more investigation queue features of the related subset associated with the investigation agent. A queue may be assigned to an investigation agent. The user may navigate an investigation agent user interface by operating a user computing entity. Through the investigation agent user interface, the user (e.g., human investigation agent) may view and access claim inventory, claim information/data, member information/data, provider information/data, and/or the like. To do so, the prospective prioritization system may provide access to the system via a user profile that has been previously established and/or stored. In an example embodiment, a user profile comprises user profile information/data, such as a user identifier configured to uniquely identify the user, a username, user contact information/data (e.g., name, one or more electronic addresses such as emails, instant message usernames, social media user name, and/or the like), user preferences, user account information/data, user credentials, information/data identifying one or more user computing entities corresponding to the user, and/or the like.

The prospective prioritization scores may be utilized to reduce the amount of data required to make a decision or take an action with respect to a predictive input entity. Instead of conducting an extensive investigation including examining data from a plurality of channels, the prospective prioritization score for a predictive input entity provides an indication of relevance and/or a degree of relevance, facilitating faster decision making for subsequent operations.

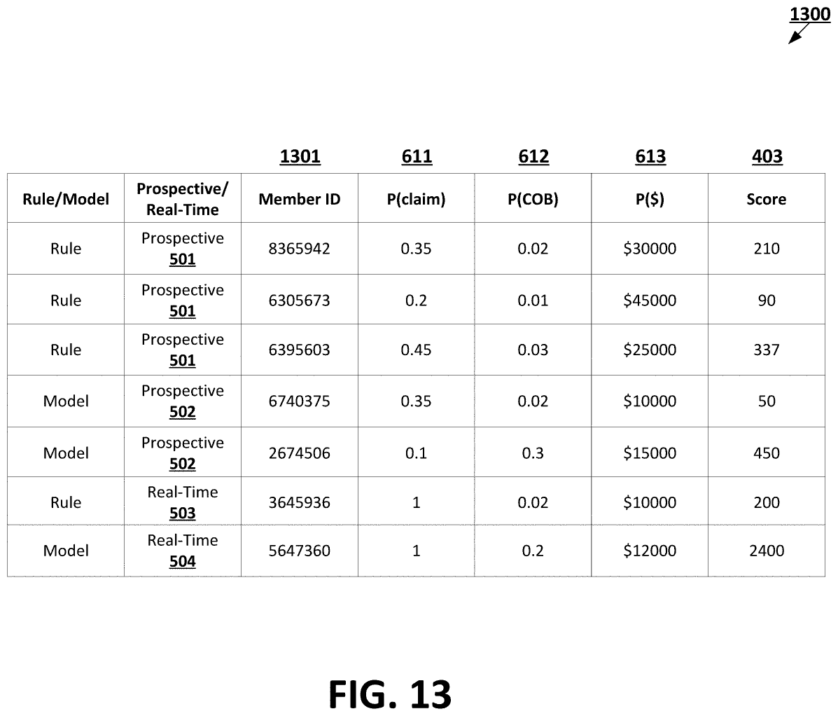

FIG. 13 illustrates an operational example showing an output of prospective prioritization operations 1300. As shown, inventory from rule-based prospective channels 501, model-based prospective channels 502, rule-based real-time channels 503 and model-based real-time channels 504 are integrated to provide a single prioritized channel/associated workflow. Each predictive input entity may be associated with a member identifier 1301. Each member identifier 1301 may refer to a data object configured to uniquely identify/determine the member (e.g., member identifier, user identifier, and/or the like), a username, user contact information/data (e.g., name (John Doe), one or more electronic addresses such as emails, instant message usernames, social media user name, and/or the like), member preferences, member account information/data, member credentials, information/data identifying/determining one or more member computing entities corresponding to the member, and/or the like. As noted, each member record/profile may correspond to a unique username, unique user identifier (e.g., 11111111), access credentials, and/or the like.

As shown, each member identifier 1301 may correspond with a member record/profile. A member record/profile refer to a data object storing and/or providing access to member information/data. The member record/profile may also comprise member information/data, member features, and/or similar words used herein interchangeably that can be associated with a given member, claim, and/or the like. In some embodiments, member information/data can include age, gender, poverty rates, known health conditions, home location, profession, access to medical care, medical history, claim history, member identifier (ID), and/or the like. Member information/data may also include marital status, employment status, employment type, socioeconomic information/data (e.g., income information/data), relationship to the primary insured, insurance product information/data, insurance plan information/data, member classifications, language information/data, and/or the like. Each member identifier 1301 may correspond with an entry, such as a table/database entry indicating the corresponding prospective qualifying criteria satisfaction predictive output 612, prospective triggering event occurrence predictive output 611, prospective cost predictive output 613 and the prospective prioritization score that is the output of the step/operation 403. In some embodiments, the member identifiers 1301/entries may be presented (sorted, organized, arranged and/or the like) in accordance with their prospective prioritization score/investigation priority.

Investigation priority may refer to an ordering of data objects describing a plurality of prospective prioritization scores (e.g., prospective priority scores) associated with each of a plurality of predictive input entities. The prospective prioritization system may generate a single prioritized channel, associated workflow and/or or one or more queues based on the prospective prioritization scores corresponding with each predictive input entity. In the context of coordination of benefits, the single prioritized channel and/or one or more queues may comprise a plurality of member identifiers, each associated with a predictive input entity, organized in accordance with a corresponding prospective priority score. In some embodiments, the investigation priority may be defined with respect to a qualifying condition.

In various embodiments, the user profile may be associated with one or more queues assigned to the investigation agent. The queues can be updated continuously, regularly, and/or in response to certain triggers. Moreover, the queues may be any of a variety of data structures that allow for efficient and dynamic prioritization and reprioritization, such as array data structures, heap data structures, map data structures, linked list data structures, tree data structures, and/or the like. Dynamically updating a queue associated with a particular investigation agent can cause an active investigation agent user interface with which the user is interacting to automatically be updated. In other embodiments, an investigation agent may be an artificial investigation agent, such as artificial intelligence (AI) bots that can perform at least some or a subset of the functions of a human investigation agent. In such an embodiment, each artificial investigation agent can be associated with one or more queues and benefit from the techniques and approaches described herein.

In some embodiments, a queue assigned to a particular user can be provided by the prospective prioritization system 101 (e.g., via a client computing entity 102) for accessing, viewing, investigating, and/or navigating via a user interface 1400 being displayed by an investigation agent user computing entity 30. Thus, the user interface 1400 can be dynamically updated to reflect the most current investigation priority order of claims, for example, assigned to a user (e.g., human investigation agent) at any given time. For instance, if a claim is received, the prospective prioritization system 101 (e.g., via a client computing entity 102) can push an update to the corresponding queue and update the investigation priority order of the queue. In another embodiment, the user interface 1400 may dynamically update the queue being displayed on a continuous or regular basis or in response to certain triggers.

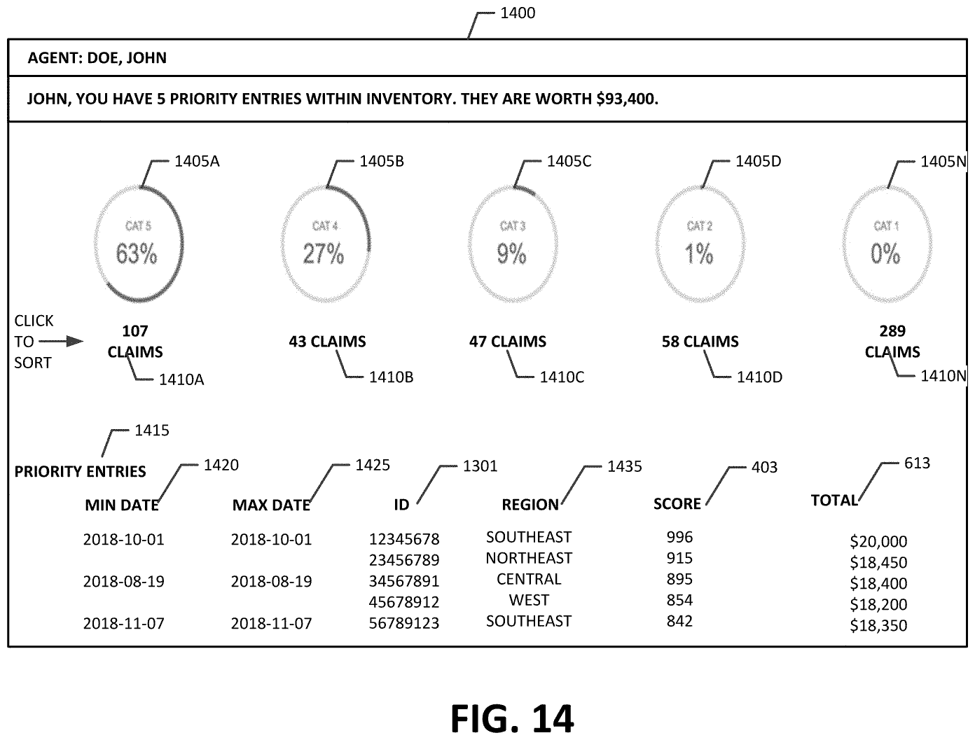

As shown in FIG. 14, the user interface 1400 may comprise various features and functionality for accessing, viewing, investigating, and/or navigating claims in open inventory or in a queue. In one embodiment, the user interface 1400 may identify the user (e.g., investigation agent) credentialed for currently accessing the user interface 1400 (e.g., John Doe). The user interface 1400 may also comprise messages to the user in the form of banners, headers, notifications, and/or the like.

In one embodiment, the user interface 1400 may display one or more claim category elements 1405A-1405N. The terms elements, indicators, graphics, icons, images, buttons, selectors, and/or the like are used herein interchangeably. In one embodiment, the claim category elements 1405A-1405N may represent respective queues assigned to a credentialed user. For example, claim category element 1405A may represent a first queue assigned to a user, claim category element 1405B may represent a second queue assigned to the user, and so on. In another embodiment, the claim category element 1405A-1405N may represent portions of a single queue assigned to the user based on threshold amounts. For example, the claim category element 1405A may represent claims having a prospective prioritization score within a first threshold, the claim category element 1405B may represent claims having a prospective prioritization score within a second threshold, and so on. In yet another embodiment, the claim category elements 1405A-1405N may comprise all of the claims in open inventory and allow for reviewing the status of claims within particular thresholds. In one embodiment, each claim category element 1405A-1405N may be selected to control what the user interface 1400 displays as the information/data in elements 1415, 1420, 1425, 1301, 1435, 1440, 613 and/or the like, as well as the output of the step/operation 403. For example, if claim category element 1405A is selected via an investigation agent user interface, elements 1415, 1420, 1425, 1301, 1435, 1440 and 613, as well as the output of the step/operation 403, are dynamically populated with information/data corresponding to priority entries (e.g., entries with the highest prospective prioritization scores).

In one embodiment, each claim category element 1405A-1405N may further be associated with category sort elements 1410A-1410N. The category sort elements 1410A-1410N may be selected to control how the user interface 1400 sorts and displays the information/data in elements 1415, 1420, 1425, 1301, 1435, 1440, 613 and/or the like, as well as the output of the step/operation 403.

In one embodiment, elements 1415, 1420, 1425, 1301, 1435, 1440, 613 and/or the like, as well as the output of the step/operation 403, may include claims (and at least a portion of their corresponding information/data) for a particular category. For example, element 1415 may be selectable for sorting and represent the category of claims selected via a claim category element 1405A-1405N. Elements 1420 and 1425 may be selectable elements for sorting and represent minimum/maximum dates the claims were submitted. Element 1301 may be selectable for sorting and represent the ID of the claim, the ID of a provider who submitted the claim, the ID of a member to whom the claim corresponds, a tax identification number of a provider, and/or the like. Elements 1435 may be selectable for sorting and represent location information for the corresponding claim line. The output of the step/operation 403 may be selectable for sorting and represent the prospective prioritization score and/or information relating to the claims being displayed. Element 613 may be selectable for sorting and represent the associated prospective cost predictive output or actual claim amount. As will be recognized, the described elements are provided for illustrative purposes and are not to be construed as limiting the dynamically updatable interface in any way. As indicated above, the user interface 1400 can be dynamically updated to show the most current investigation priority order of claims at an inventory level, a queue level, and/or the like.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for performing prospective prioritization of a plurality of predictive input entities, the computer-implemented method comprising:
for each predictive input entity of the plurality of predictive input entities,
determining a predictive input channel of a plurality of predictive input channels that is associated with the predictive input entity, wherein the plurality of predictive input channels comprise a model-based prospective channel, a rule-based prospective channel, a model-based real-time channel, and a rule-based real-time channel;
determining a prospective triggering event occurrence predictive output for the predictive input entity based on the predictive input channel for the predictive input entity;
determining a prospective qualifying criteria satisfaction predictive output for the predictive input entity based on the predictive input channel for the predictive input entity;
determining a prospective cost predictive output for the predictive input entity based on the predictive input channel for the predictive input entity; and
determining the prospective priority score for the predictive input entity based on the prospective triggering event occurrence predictive output for the predictive input entity, the prospective qualifying criteria satisfaction predictive output for the predictive input entity, and the prospective cost predictive output for the predictive input entity; and
performing the prospective prioritization based on each prospective priority score for a predictive input entity of the plurality of predictive input entities.

2. The computer-implemented method of claim 1, wherein:
the plurality of predictive input entities comprise a first predictive input entity that is associated with the model-based prospective channel;
the prospective triggering event occurrence predictive output for the first predictive input entity is determined using a trained event-based historical interpolation model, where the trained event-based historical interpolation model is configured to process per-entity historical triggering event data associated with the first predictive input entity to generate the prospective triggering event occurrence predictive output for the first predictive input entity;
the prospective qualifying criteria satisfaction predictive output for the first predictive input entity is determined using a trained criteria satisfaction model, wherein the trained criteria satisfaction model is configured to process per-entity criteria-related feature data associated with the first predictive input entity to generate the prospective qualifying criteria satisfaction predictive output for the first predictive input entity; and
the prospective cost predictive output for the first predictive input entity is determined using a trained prospective cost prediction model, wherein the trained prospective cost prediction model is configured to process per-entity historical cost data associated with the first predictive entity to generate the prospective cost predictive output for the first predictive entity.

3. The computer-implemented method of claim 1, wherein:
the plurality of predictive input entities comprise a first predictive input entity that is associated with the rule-based prospective channel;
the prospective triggering event occurrence predictive output for the first predictive input entity is determined using a trained event-based historical interpolation model, where the trained event-based historical interpolation model is configured to process per-entity historical triggering event data associated with the first predictive input entity to generate the prospective triggering event occurrence predictive output for the first predictive input entity;
the prospective qualifying criteria satisfaction predictive output for the first predictive input entity is determined using a trained rule-parameterized criteria satisfaction model, wherein the trained rule-parameterized criteria satisfaction model is configured to process per-entity criteria-related feature data associated with the first predictive input entity and per-entity rule satisfaction data associated with the first predictive input entity in accordance with one or more model parameters comprising one or more rule effectiveness parameters to generate the prospective qualifying criteria satisfaction predictive output for the first predictive input entity; and
the prospective cost predictive output for the first predictive input entity is determined using a trained prospective cost prediction model, wherein the trained prospective cost prediction model is configured to process per-entity historical cost data associated with the first predictive entity to generate the prospective cost predictive output for the first predictive entity.

4. The computer-implemented method of claim 1, wherein:
the plurality of predictive input entities comprise a first predictive input entity that is associated with the model-based real-time channel;
the prospective triggering event occurrence predictive output for the first predictive input entity is determined based on a maximal triggering event occurrence prediction value;
the prospective qualifying criteria satisfaction predictive output for the first predictive input entity is determined using a trained criteria satisfaction model, wherein the trained criteria satisfaction model is configured to process per-entity criteria-related feature data associated with the first predictive input entity to generate the prospective qualifying criteria satisfaction predictive output for the first predictive input entity;
the prospective cost predictive output for the first predictive input entity is determined using a larger value of a real-time prospective cost predictive output for the first predictive input entity and an inferred prospective cost predictive output for the first predictive input entity; and
the inferred prospective cost predictive output for the first predictive input entity is determined using a trained prospective cost prediction model, wherein the trained prospective cost prediction model is configured to process per-entity historical cost data associated with the first predictive entity to generate the inferred prospective cost predictive output for the first predictive entity.

5. The computer-implemented method of claim 1, wherein:
the plurality of predictive input entities comprise a first predictive input entity that is associated with the rule-based real-time channel;
the prospective triggering event occurrence predictive output for the first predictive input entity is determined based on a maximal triggering event occurrence prediction value;
the perspective qualifying criteria satisfaction prediction for the first predictive input entity is determined using a trained rule-parameterized criteria satisfaction model, wherein the trained rule-parameterized criteria satisfaction model is configured to process per-entity criteria-related feature data associated with the first predictive entity and per-entity rule satisfaction data associated with the first predictive input entity in accordance with one or more model parameters comprising one or more rule effectiveness parameters to generate the prospective qualifying criteria satisfaction predictive output for the first predictive input entity;
the prospective cost predictive output for the first predictive input entity is determined using a larger value of a real-time prospective cost predictive output for the first predictive input entity and an inferred prospective cost predictive output for the first predictive input entity; and
the inferred prospective cost predictive output for the first predictive input entity is determined using a trained prospective cost prediction model, wherein the trained prospective cost prediction model is configured to process per-entity historical cost data associated with the first predictive entity to generate the inferred prospective cost predictive output for the first predictive entity.

6. The computer-implemented method of claim 1, wherein:
each predictive input entity of the plurality of predictive input entities is associated with a member identifier of a plurality of member identifiers, and
the prospective priority score for each member identifier of the plurality of member identifier describes an investigation priority of the member identifier with respect to the qualifying condition.

7. The computer-implemented method of claim 6, wherein:
each prospective triggering event occurrence predictive output for a predictive input entity of the plurality of predictive input entities describes a claim filing prediction for the member identifier that is associated with the predictive input entity,
each prospective qualifying criteria satisfaction predictive output for a predictive input entity of the plurality of predictive input entities describes a coordination of benefits scenario prediction for the member identifier that is associated with the predictive input entity, and
each prospective cost predictive output for a predictive input entity of the plurality of predictive input entities describes a cumulative claim cost for the member identifier that is associated with the predictive input entity.

8. The computer-implemented method of claim 1, wherein performing the prospective prioritization comprises:
assigning each predictive input entity of the plurality of predictive input entities to an investigation agent of one or more investigation agents based on the prospective priority score of the predictive input entities, and
causing each investigation agent of the one or more investigation agents to process a related subset of the plurality of predictive input entities that is associated with the investigation agent.

9. The computer-implemented method of claim 8, further comprising:
for each investigation agent of the one or more investigation agents, generating an investigation agent user interface for the investigation agent that describes one or more investigation queue features of the related subset associated with the investigation agent.

10. The computer-implemented method of claim 9, wherein the one or more investigation queue features for the related subset of an investigation agent of the one or more investigation agents comprise:
each prospective triggering event occurrence predictive output for a predictive input entity of the plurality of predictive input entities that is associated with the related subset,
each prospective qualifying criteria satisfaction predictive output for a predictive input entity of the plurality of predictive input entities that is associated with the related subset,
each cost prediction for a predictive input entity of the plurality of predictive input entities that is associated with the related subset, and
each prospective priority score for a predictive input entity of the plurality of predictive input entities that is associated with the related subset.

11. An apparatus for performing prospective prioritization of a plurality of predictive input entities, the apparatus comprising at least one processor and at least one memory including a computer program code, the at least one memory and the computer program code configured to, with the at least one processor, cause the apparatus to:
for each predictive input entity of the plurality of predictive input entities,
determine a predictive input channel of a plurality of predictive input channels that is associated with the predictive input entity, wherein the plurality of predictive input channels comprise a model-based prospective channel, a rule-based prospective channel, a model-based real-time channel, and a rule-based real-time channel;
determine a prospective triggering event occurrence predictive output for the predictive input entity based on the predictive input channel for the predictive input entity;
determine a prospective qualifying criteria satisfaction predictive output for the predictive input entity based on the predictive input channel for the predictive input entity;
determine a prospective cost predictive output for the predictive input entity based on the predictive input channel for the predictive input entity; and
determine the prospective priority score for the predictive input entity based on the prospective triggering event occurrence predictive output for the predictive input entity, the prospective qualifying criteria satisfaction predictive output for the predictive input entity, and the prospective cost predictive output for the predictive input entity; and
perform the prospective prioritization based on each prospective priority score for a predictive input entity of the plurality of predictive input entities.

12. The apparatus of claim 11, wherein:
the plurality of predictive input entities comprise a first predictive input entity that is associated with the model-based prospective channel;
the prospective triggering event occurrence predictive output for the first predictive input entity is determined using a trained event-based historical interpolation model, where the trained event-based historical interpolation model is configured to process per-entity historical triggering event data associated with the first predictive input entity to generate the prospective triggering event occurrence predictive output for the first predictive input entity;
the prospective qualifying criteria satisfaction predictive output for the first predictive input entity is determined using a trained criteria satisfaction model, wherein the trained criteria satisfaction model is configured to process per-entity criteria-related feature data associated with the first predictive input entity to generate the prospective qualifying criteria satisfaction predictive output for the first predictive input entity; and
the prospective cost predictive output for the first predictive input entity is determined using a trained prospective cost prediction model, wherein the trained prospective cost prediction model is configured to process per-entity historical cost data associated with the first predictive entity to generate the prospective cost predictive output for the first predictive entity.

13. The apparatus of claim 11, wherein:
the plurality of predictive input entities comprise a first predictive input entity that is associated with the rule-based prospective channel;
the prospective triggering event occurrence predictive output for the first predictive input entity is determined using a trained event-based historical interpolation model, where the trained event-based historical interpolation model is configured to process per-entity historical triggering event data associated with the first predictive input entity to generate the prospective triggering event occurrence predictive output for the first predictive input entity;
the prospective qualifying criteria satisfaction predictive output for the first predictive input entity is determined using a trained rule-parameterized criteria satisfaction model, wherein the trained rule-parameterized criteria satisfaction model is configured to process per-entity criteria-related feature data associated with the first predictive input entity and per-entity rule satisfaction data associated with the first predictive input entity in accordance with one or more model parameters comprising one or more rule effectiveness parameters to generate the prospective qualifying criteria satisfaction predictive output for the first predictive input entity; and
the prospective cost predictive output for the first predictive input entity is determined using a trained prospective cost prediction model, wherein the trained prospective cost prediction model is configured to process per-entity historical cost data associated with the first predictive entity to generate the prospective cost predictive output for the first predictive entity.

14. The apparatus of claim 11, wherein:
the plurality of predictive input entities comprise a first predictive input entity that is associated with the model-based real-time channel;
the prospective triggering event occurrence predictive output for the first predictive input entity is determined based on a maximal triggering event occurrence prediction value;
the prospective qualifying criteria satisfaction predictive output for the first predictive input entity is determined using a trained criteria satisfaction model, wherein the trained criteria satisfaction model is configured to process per-entity criteria-related feature data associated with the first predictive input entity to generate the prospective qualifying criteria satisfaction predictive output for the first predictive input entity;
the prospective cost predictive output for the first predictive input entity is determined using a larger value of a real-time prospective cost predictive output for the first predictive input entity and an inferred prospective cost predictive output for the first predictive input entity; and
the inferred prospective cost predictive output for the first predictive input entity is determined using a trained prospective cost prediction model, wherein the trained prospective cost prediction model is configured to process per-entity historical cost data associated with the first predictive entity to generate the inferred prospective cost predictive output for the first predictive entity.

15. The apparatus of claim 11, wherein:
the plurality of predictive input entities comprise a first predictive input entity that is associated with the rule-based real-time channel;
the prospective triggering event occurrence predictive output for the first predictive input entity is determined based on a maximal triggering event occurrence prediction value;
the perspective qualifying criteria satisfaction prediction for the first predictive input entity is determined using a trained rule-parameterized criteria satisfaction model, wherein the trained rule-parameterized criteria satisfaction model is configured to process per-entity criteria-related feature data associated with the first predictive entity and per-entity rule satisfaction data associated with the first predictive input entity in accordance with one or more model parameters comprising one or more rule effectiveness parameters to generate the prospective qualifying criteria satisfaction predictive output for the first predictive input entity;
the prospective cost predictive output for the first predictive input entity is determined using a larger value of a real-time prospective cost predictive output for the first predictive input entity and an inferred prospective cost predictive output for the first predictive input entity; and
the inferred prospective cost predictive output for the first predictive input entity is determined using a trained prospective cost prediction model, wherein the trained prospective cost prediction model is configured to process per-entity historical cost data associated with the first predictive entity to generate the inferred prospective cost predictive output for the first predictive entity.

16. A non-transitory computer storage medium comprising instructions for performing prospective prioritization of a plurality of predictive input entities, the instructions being configured to cause one or more processors to at least perform operations configured to:
for each predictive input entity of the plurality of predictive input entities,
determine a predictive input channel of a plurality of predictive input channels that is associated with the predictive input entity, wherein the plurality of predictive input channels comprise a model-based prospective channel, a rule-based prospective channel, a model-based real-time channel, and a rule-based real-time channel;
determine a prospective triggering event occurrence predictive output for the predictive input entity based on the predictive input channel for the predictive input entity;
determine a prospective qualifying criteria satisfaction predictive output for the predictive input entity based on the predictive input channel for the predictive input entity;
determine a prospective cost predictive output for the predictive input entity based on the predictive input channel for the predictive input entity; and
determine the prospective priority score for the predictive input entity based on the prospective triggering event occurrence predictive output for the predictive input entity, the prospective qualifying criteria satisfaction predictive output for the predictive input entity, and the prospective cost predictive output for the predictive input entity; and
perform the prospective prioritization based on each prospective priority score for a predictive input entity of the plurality of predictive input entities.

17. The non-transitory computer storage medium of claim 16, wherein:
the plurality of predictive input entities comprise a first predictive input entity that is associated with the model-based prospective channel;
the prospective triggering event occurrence predictive output for the first predictive input entity is determined using a trained event-based historical interpolation model, where the trained event-based historical interpolation model is configured to process per-entity historical triggering event data associated with the first predictive input entity to generate the prospective triggering event occurrence predictive output for the first predictive input entity;
the prospective qualifying criteria satisfaction predictive output for the first predictive input entity is determined using a trained criteria satisfaction model, wherein the trained criteria satisfaction model is configured to process per-entity criteria-related feature data associated with the first predictive input entity to generate the prospective qualifying criteria satisfaction predictive output for the first predictive input entity; and
the prospective cost predictive output for the first predictive input entity is determined using a trained prospective cost prediction model, wherein the trained prospective cost prediction model is configured to process per-entity historical cost data associated with the first predictive entity to generate the prospective cost predictive output for the first predictive entity.

18. The non-transitory computer storage medium of claim 16, wherein:
the plurality of predictive input entities comprise a first predictive input entity that is associated with the rule-based prospective channel;
the prospective triggering event occurrence predictive output for the first predictive input entity is determined using a trained event-based historical interpolation model, where the trained event-based historical interpolation model is configured to process per-entity historical triggering event data associated with the first predictive input entity to generate the prospective triggering event occurrence predictive output for the first predictive input entity;
the prospective qualifying criteria satisfaction predictive output for the first predictive input entity is determined using a trained rule-parameterized criteria satisfaction model, wherein the trained rule-parameterized criteria satisfaction model is configured to process per-entity criteria-related feature data associated with the first predictive input entity and per-entity rule satisfaction data associated with the first predictive input entity in accordance with one or more model parameters comprising one or more rule effectiveness parameters to generate the prospective qualifying criteria satisfaction predictive output for the first predictive input entity; and
the prospective cost predictive output for the first predictive input entity is determined using a trained prospective cost prediction model, wherein the trained prospective cost prediction model is configured to process per-entity historical cost data associated with the first predictive entity to generate the prospective cost predictive output for the first predictive entity.

19. The non-transitory computer storage medium of claim 16, wherein:
the plurality of predictive input entities comprise a first predictive input entity that is associated with the model-based real-time channel;
the prospective triggering event occurrence predictive output for the first predictive input entity is determined based on a maximal triggering event occurrence prediction value;
the prospective qualifying criteria satisfaction predictive output for the first predictive input entity is determined using a trained criteria satisfaction model, wherein the trained criteria satisfaction model is configured to process per-entity criteria-related feature data associated with the first predictive input entity to generate the prospective qualifying criteria satisfaction predictive output for the first predictive input entity;
the prospective cost predictive output for the first predictive input entity is determined using a larger value of a real-time prospective cost predictive output for the first predictive input entity and an inferred prospective cost predictive output for the first predictive input entity; and
the inferred prospective cost predictive output for the first predictive input entity is determined using a trained prospective cost prediction model, wherein the trained prospective cost prediction model is configured to process per-entity historical cost data associated with the first predictive entity to generate the inferred prospective cost predictive output for the first predictive entity.

20. The non-transitory computer storage medium of claim 16, wherein:
the plurality of predictive input entities comprise a first predictive input entity that is associated with the rule-based real-time channel;
the prospective triggering event occurrence predictive output for the first predictive input entity is determined based on a maximal triggering event occurrence prediction value;
the perspective qualifying criteria satisfaction prediction for the first predictive input entity is determined using a trained rule-parameterized criteria satisfaction model, wherein the trained rule-parameterized criteria satisfaction model is configured to process per-entity criteria-related feature data associated with the first predictive entity and per-entity rule satisfaction data associated with the first predictive input entity in accordance with one or more model parameters comprising one or more rule effectiveness parameters to generate the prospective qualifying criteria satisfaction predictive output for the first predictive input entity;
the prospective cost predictive output for the first predictive input entity is determined using a larger value of a real-time prospective cost predictive output for the first predictive input entity and an inferred prospective cost predictive output for the first predictive input entity; and
the inferred prospective cost predictive output for the first predictive input entity is determined using a trained prospective cost prediction model, wherein the trained prospective cost prediction model is configured to process per-entity historical cost data associated with the first predictive entity to generate the inferred prospective cost predictive output for the first predictive entity.
